(19) United States
(12) Patent Application Publication
(10) Pub. No.: US 2023/0081387 A1
(43) Pub. Date: Mar. 16, 2023

(54) MOBILE AUDIOVISUAL DEVICE AND CONTROL METHOD OF VIDEO PLAYBACK

(71) Applicants: Inventec (Pudong) Technology Corporation, Shanghai (CN); INVENTEC CORPORATION, Taipei (TW)

(72) Inventor: Kuo-Chi TING, Taipei (TW)

(21) Appl. No.: 17/548,686

(22) Filed: Dec. 13, 2021

(30) Foreign Application Priority Data
Sep. 14, 2021 (CN) 202111075959.8

(51) Int. Cl. G06F 3/16; G06V 20/40; G06T 7/246; G06V 40/20; G10L 17/06

(52) U.S. Cl. CPC G06F 3/165; G06V 20/40; G06T 7/246; G06V 40/20; G10L 17/06; G06T 2207/10016; G06T 2207/30196

(57) ABSTRACT

A control method of video playback comprises: utilizing a display interface to display a plurality of frames of a video, and utilizing an audio output interface to output an audio signal of the video; utilizing an input interface to receive an indication signal; utilizing a processor to acquire a target character pattern in a current frame of the display interface according to the indication signal, wherein the indication signal indicates a frame coordinate, and the target character pattern corresponds to the frame coordinate and corresponds to one of the plurality of character motions; utilizing the processor to extract a determined audio track corresponding to the target character pattern from the audio signal according to a relation between the plurality of character motions and the plurality of pre-processed audio tracks; utilizing the processor to control the audio output interface to output the determined audio track.

### CROSS-REFERENCE TO RELATED APPLICATIONS

This non-provisional application claims priority under 35 U.S.C. § 119(a) on Patent Application No(s). 202111075959.8 filed in China on Sep. 14, 2021, the entire contents of which are hereby incorporated by reference.

### BACKGROUND

### 1. Technical Field

This disclosure relates to a control method of video playback.

### 2. Related Art

Nowadays, 3C products (e.g. mobile devices such as laptops, tablets, mobile phones, etc.) are equipped with functions of playing videos and audios, so that users can watch videos on devices. For example, user may store videos into a memory of the mobile device via a transmission port, and utilizes an application of the mobile device to watch videos. In addition, users may watch videos via internet connection of the mobile device to watch videos on platforms such as Youtube, Netflix, Apple TV+, myVideo, etc., or download videos from the platforms to watch in an offline mode. However, when the current mobile devices plays a video, the audio thereof is also played along.

### SUMMARY

In light of the foregoing description, this disclosure provides a mobile audiovisual device and control method of video playback and may provide an audio signal corresponding to the specified character pattern.

According to one or more embodiment of the mobile audiovisual device, the mobile audiovisual device comprises an input interface, a display interface, an audio output interface, a memory and a processor. Wherein, the processor is connected to the input interface, the display interface, the audio output interface, the memory and the processor. The input interface is arranged to receive an indication signal. The display interface is arranged to display a plurality of frames of a video. The audio output interface is arranged to output an audio signal of the video. The memory stores a relation between a plurality of character motions and a plurality of pre-processed audio tracks. The processor is arranged to perform following steps: acquiring a target character pattern in a current frame of the display interface according to the indication signal, wherein the indication signal indicates a frame coordinate, and the target character pattern corresponds to the frame coordinate and corresponds to one of the plurality of character motions; extracting a determined audio track corresponding to the target character pattern from the audio signal according to the relation between the plurality of character motions and the plurality of pre-processed audio tracks; controlling the audio output interface to output the determined audio track.

According to one or more embodiment of the control method of video playback, the control method of video playback comprises: utilizing a display interface to display a plurality of frames of a video, and utilizing an audio output interface to output an audio signal of the video; utilizing an input interface to receive an indication signal; utilizing a processor to acquire a target character pattern in a current frame of the display interface according to the indication signal, wherein the indication signal indicates a frame coordinate, and the target character pattern corresponds to the frame coordinate and corresponds to one of the plurality of character motions; utilizing the processor to extract a determined audio track corresponding to the target character pattern from the audio signal according to a relation between the plurality of character motions and the plurality of pre-processed audio tracks; utilizing the processor to control the audio output interface to output the determined audio track.

With the foregoing configuration, the mobile audiovisual device and control method of video playback provided the present disclosure determine, based on the relation between the plurality of character motions and the plurality of pre-processed audio track, that the character pattern specified by the indication signal received by the input interface has the character motion and the audio track corresponding to the character motion. The present invention may provide the function of playing the sound corresponding to the specified character alone.

The foregoing context of the present disclosure and the detailed description given herein below are used to demonstrate and explain the concept and the spirit of the present invention and provides the further explanation of the claim of the present invention.

### BRIEF DESCRIPTION OF THE DRAWINGS

FIG. 1 is a block diagram of the mobile audiovisual device according to one embodiment of the present invention.

FIG. 2 is a flowchart of the control method of video playback according to one embodiment of the present invention.

FIG. 3 is a pre-processing flowchart of the control method of video playback according to one embodiment of the present invention.

FIG. 4 is a diagram illustrating a displayed image of a video according to one embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

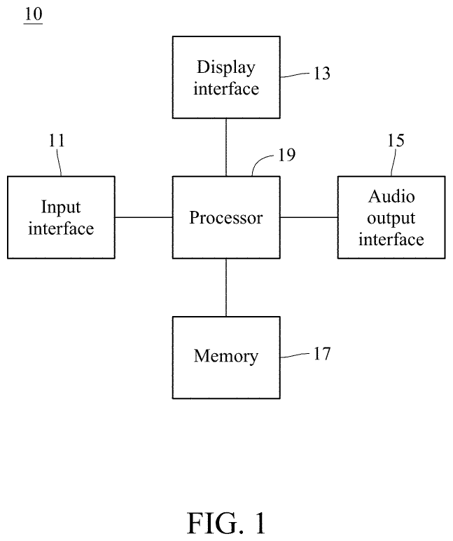

Please refer to FIG. 1, which is a block diagram of the mobile audiovisual device according to one embodiment of the present invention. As shown in FIG. 1, the mobile audiovisual device 10 comprises an input interface 11, a display interface 13, an audio output interface 15, a memory 17 and a processor 19, wherein the processor 19 is connected to the input interface 11, the display interface 13, the audio output interface 15, and the memory 17 via a wired or wireless connection. Specially, the mobile audiovisual device 10 may be a laptop, a tablet, a mobile phone, and other mobile devices with the function of playing videos, but the present invention is not limited thereto.

The input interface 11 is arranged to receive an indication signal. For example, the input interface 11 may be a mouse or of the laptop, a touch interface of the tablet or a touch interface of the mobile phone. In one embodiment, the indication signal is a single-click signal, and a trigger position of the single-click signal corresponds to a specified frame coordinate on the frames of the display interface 13. In another embodiment, the indication signal is a sliding signal indicating a closed curve, and a geometric center position of the closed curve corresponds to a specified frame coordinate on the frames of the display interface 13. For example, the display interface 13 may be a screen of the laptop, the tablet and the mobile phone, and the audio output interface 15 may be a speaker. The display interface 13 and the audio output interface 15 are arranged to play videos. Further, the display interface 13 is arranged to display a plurality of frames of the video, and the audio output interface 15 is arranged to output audio signals of the video.

For example, the memory 17 may be a flash memory, hard disk drive (HDD), solid-state disk (SSD), dynamic random access memory (DRAM), static random access memory (SRAM) or other type of non-volatile memories. The memory 17 may be a local storage or a remote storage such as the cloud database. The memory 17 stores a relation between a plurality of character motions and a plurality of pre-processed audio tracks, wherein the relation may be stored in the manner of look-up table. For example, the processor 19 may be the central processing unit, the microcontroller, the programmable logic controller (PLC) or other type of processors. The processor 19 is arranged to process the video based on the indication signal received by the input interface 11 to play the sounds corresponding to specified characters. The detailed execution step would be described below.

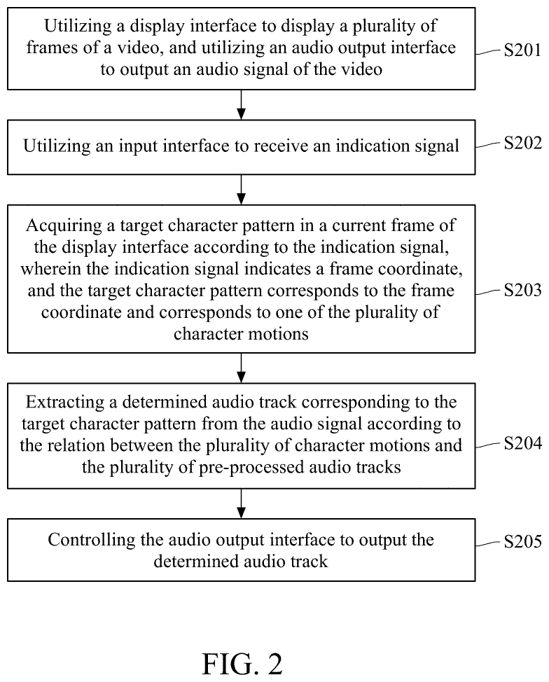

Please refer to FIG. 1 and FIG. 2, and FIG. 2 is a flowchart of the control method of video playback according to one embodiment of the present invention. As shown in FIG. 2, the control method of video playback may comprise steps S201-S205. The control method of video playback shown in FIG. 2 may be performed by the mobile audiovisual device 10 shown in FIG. 1, but the present invention is not limited thereto. For better understanding, operations of the mobile audiovisual device 10 are mentioned to illustrate the control method of video playback shown in FIG. 2.

In step S201, the mobile audiovisual device 10 utilizes the display interface 13 to display the plurality of frames of the video, and utilizes the audio output interface 15 to output the audio signal of the video. In step S202, the mobile audiovisual device 10 utilizes the input interface 11 to receive the indication signal, and then the mobile audiovisual device 10 utilizes the processor 19 to execute steps S203-S204. In step S203, the processor 19 acquires a target character pattern in a current frame of the display interface according to the indication signal, wherein the indication signal indicates a frame coordinate, and the target character pattern corresponds to the frame coordinate and corresponds to one of the plurality of character motions. As mentioned above, the indication signal may be a single-click signal or a sliding signal to indicate a specified coordinate on the frame of the display interface 13. The processor 19 may determine a feature block among one or more of the plurality of feature blocks in the current frame that is closest to the specified coordinate (e.g. a frame coordinate) as the target character pattern (such as the geometric center coordinate provided with a shortest distance to the specified coordinate). Further, the video may be processed with the artificial intelligence (AI) technology by the processor 19 or an exterior processor (e.g. the cloud server) before playing the video, to acquire one or more feature blocks. The processor 19 or an exterior processor determines character motions corresponding to these feature blocks and marks these feature blocks with labels corresponding to the character motions. The detailed processing manner is described below.

In step S204, the processor 19 extracts a determined audio track corresponding to the target character pattern from the audio signal according to the relation between the plurality of character motions and the plurality of pre-processed audio tracks. As mentioned above, the target character pattern corresponds to one of the plurality of character motions, and the processor 19 determines the pre-processed audio track corresponding to the target character pattern. Further, the audio signal of the video may be processed with the artificial intelligence (AI) technology by the processor 19 or an exterior processor (e.g. the cloud server) before playing the video, to acquire the plurality of pre-processed audio tracks. In one embodiment, pre-processed audio tracks are acquired by processing the partial audio signal of the video. The processor 19 may extract the determined audio track with the same voiceprint from the audio signal according to the voiceprint of the pre-processed audio track corresponding to the target character pattern. In another embodiment, pre-processed audio tracks are acquired by processing the entire audio signal of the video. The processor 19 may use the pre-processed audio track corresponding to the target character pattern as the determined audio track.

In step S205, the processor 19 controls the audio output interface 15 to output the determined audio track. In one embodiment, the processor 19 may control the audio output interface 15 to only output the determined audio track without outputting the other audio tracks in the audio signal. In another embodiment, the processor 19 may control the audio output interface 15 to output the determined audio track of which volume is higher than other audio tracks.

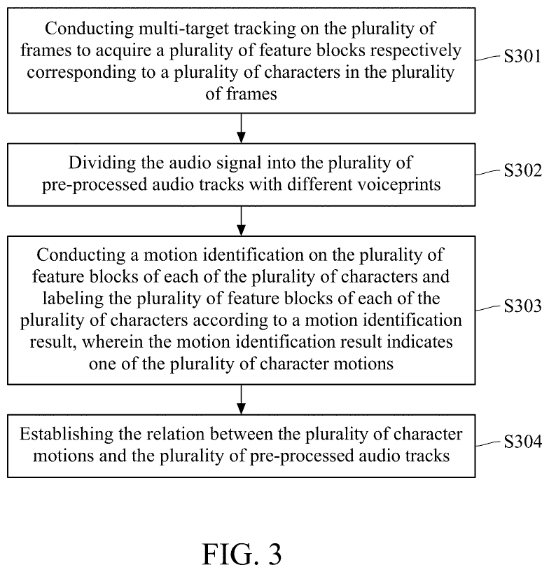

As mentioned above, the frames and audio signal may be processed with the artificial intelligence (AI) technology by the processor 19 or an exterior processor (e.g. the cloud server) before playing the video to acquire feature blocks in each frame, the plurality of audio tracks provided by the audio signal and the relation between character motions and audio tracks, and the processor 19 or an exterior processor stores them in the memory 17. The detailed processing steps would be referred to FIG. 3, and FIG. 3 is a pre-processing flowchart of the control method of video playback according to one embodiment of the present invention. As shown in FIG. 3, the control method of video playback may comprise steps S301-S304.

In step S301, the processor 19 conducts multi-target tracking on the plurality of frames of the video to acquire the plurality of feature blocks in the plurality of frames corresponding to the plurality of characters. Specially, the plurality of frames are entire frames of the video. Further, the multi-target tracking conducted by the processor 19 may comprise: adjusting a frame; inputting the adjusted frame to a pre-trained object detection model (such as Yolov3 or other detection models with regard to detecting characters) to generate a plurality of bounding boxes; inputting a plurality of bounding boxes to the tracker to obtain tracking results of the plurality of characters, which are the feature block of each character in each frame, wherein the tracker may conduct a multi-target tracking algorithm on the inputted data, such as the Simple Online and Real-time Tracking (SORT) algorithm.

In step S302, the processor 19 divides the audio signal into the plurality of pre-processed audio tracks with different voiceprints. Further, the processor 19 utilizes a pre-trained sound source separation model to divide the audio signal into the plurality of pre-processed audio tracks with different voiceprints. For example, the sound source separation model is a machine learning model pre-trained by a plurality of data about human voice, drum voice, guitar voice and/or voice from the other instruments and AI music source separation in the waveform domain technology. Wherein, the AI music source separation in the waveform domain technology, for example, is DEMUCS. The audio signal may be divided into audio tracks with different human voices or voices of instruments by the sound source separation model. Here, it should be noted that the processor 19 may conduct pre-processing on the frames and conduct the pre-processing on the audio signal of the frames simultaneously or separately. In addition to conducting the step S301, as shown in FIG. 3, the step 302 may be conducted with step S301 at the same time or may be conducted before step S301.

In step S303, the processor 19 conducts a motion identification on the plurality of feature blocks of each of the plurality of characters, and labels the plurality of feature blocks of each of the plurality of characters according to a motion identification result, wherein the motion identification result indicates one of the plurality of character motions. Further, the processor 19 may input the plurality of feature blocks of each of the plurality of characters in each of the plurality of frames to the pre-trained motion identification model to identify motions of each of the plurality of characters (i.e. acquiring the motion identification result). For example, the motion identification model is the machine learning model pre-trained by a plurality of motion images about singing, playing the drum, playing the guitar and/or playing the other instruments, and singing, playing the drum, playing the guitar and/or playing the other instruments are the plurality of character motions. The processor 19 may mark characters in frames with different character motions with different labels, to determine the character motion corresponding to the feature block when the following feature block is selected according to the indication signal (i.e. the step S203 mentioned above).

In step S304, the processor 19 establishes the relation between the plurality of character motions and the plurality of pre-processed audio tracks. Further, the processor 19 may mark audio tracks with human voices with a label denoting “singing”, mark audio tracks with drum voices with a label denoting “playing the drum,” and mark audio tracks with guitar voices with a label denoting “playing the guitar”. In another example, the processor 19 may record the relation between the foregoing audio tracks and the motion labels using a lookup table. The foregoing marking rule may be preset in the processor 19, such as user settings. In addition, it should be noted that the aforementioned step S303 is executed after step S301, and the aforementioned step S304 is executed after step S302. The execution orders of the rest steps are not specifically limited.

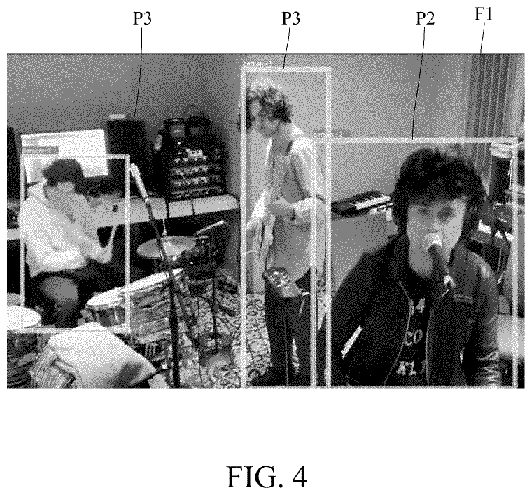

Set an example to illustrate contexts of the foregoing control method of video playback. Please refer to FIG. 4, which is a video frame schematic diagram according to one embodiment of the present invention. As shown in FIG. 4, frame F1 is provided with the pre-processed feature blocks P1-P3. The feature block P1 is marked with the label denoting “playing the drum”, the feature block P2 is marked with the label denoting “singing”, and the feature block P3 is marked with the label denoting “playing the guitar”. When the user clicks the feature block P1 by the input interface 11, the processor 19 determines that the frame coordinate indicated by the indication signal is closest to the geometric center coordinate of the feature block P1, and controls the audio output interface 15 to output audio tracks of the drum voice. Similarly, when user clicks the feature block P2, the audio output interface 15 outputs audio tracks of the guitar voice. When user clicks the feature block P3, the audio output interface 15 outputs audio tracks of human voices. Specially, gray frames of feature blocks P1-P3 shown in FIG. 4 is merely for illustrative purposes, and may not be displayed on the image.

With the foregoing configuration, the mobile audiovisual device and control method of video playback of the present disclosure determines that the character pattern specified by the indication signal received by the input interface 11 has the character motion and the audio track corresponding to the character motion based on the relation between the plurality of character motions and the plurality of pre-processed audio track. The present invention may provide the function of playing the sound corresponding to the specified character alone.

Although embodiments of the present invention are disclosed as the above, it is not meant to limit the scope of the present invention. Any possible modifications and variations based on the embodiments of the present inventions shall fall within the claimed scope of the present invention. The claimed scope of the present invention is defined by the claim as follows.

What is claimed is:

1. A mobile audiovisual device comprising:
an input interface, arranged to receive an indication signal;
a display interface, arranged to display a plurality of frames of a video;
an audio output interface, arranged to output an audio signal of the video;
a memory storing a relation between a plurality of character motions and a plurality of pre-processed audio tracks; and
a processor connected to the input interface, the display interface, the audio output interface and the memory, and arranged to perform following steps:
acquiring a target character pattern in a current frame of the display interface according to the indication signal, wherein the indication signal indicates a frame coordinate, and the target character pattern corresponds to the frame coordinate and corresponds to one of the plurality of character motions;
extracting a determined audio track corresponding to the target character pattern from the audio signal according to the relation between the plurality of character motions and the plurality of pre-processed audio tracks; and
controlling the audio output interface to output the determined audio track.

2. The mobile audiovisual device according to claim 1, wherein the processor further comprises:
conducting multi-target tracking on the plurality of frames to acquire a plurality of feature blocks respectively corresponding to a plurality of characters in the plurality of frames;
dividing the audio signal into the plurality of pre-processed audio tracks with different voiceprints;
conducting a motion identification on the plurality of feature blocks of each of the plurality of characters and labeling the plurality of feature blocks of each of the plurality of characters according to a motion identification result, wherein the motion identification result indicates one of the plurality of character motions; and
establishing the relation between the plurality of character motions and the plurality of pre-processed audio tracks.

3. The mobile audiovisual device according to claim 1, wherein the step of acquiring the target character pattern in the current frame of the display interface according to the indication signal performed by the processor comprises:
determining a feature block among one or more of a plurality of feature blocks in the current frame that is closest to the frame coordinate as the target character pattern.

4. The mobile audiovisual device according to claim 1, wherein the indication signal is a single-click signal, and a trigger position of the single-click signal corresponds to the frame coordinate.

5. The mobile audiovisual device according to claim 1, wherein the indication signal is a sliding signal, the sliding signal indicates a closed curve, and a geometric center position of the closed curve corresponds to the frame coordinate.

6. A control method of video playback comprising:
utilizing a display interface to display a plurality of frames of a video, and utilizing an audio output interface to output an audio signal of the video;
utilizing an input interface to receive an indication signal;
utilizing a processor to acquire a target character pattern in a current frame of the display interface according to the indication signal, wherein the indication signal indicates a frame coordinate, and the target character pattern corresponds to the frame coordinate and corresponds to one of a plurality of character motions;
utilizing the processor to extract a determined audio track corresponding to the target character pattern from the audio signal according to a relation between the plurality of character motions and a plurality of pre-processed audio tracks; and
utilizing the processor to control the audio output interface to output the determined audio track.

7. The control method of video playback according to claim 6, the control method of video playback further comprises steps performed by the processor:
conducting multi-target tracking on the plurality of frames to acquire a plurality of feature blocks respectively corresponding to a plurality of characters in the plurality of frames;
dividing the audio signal into the plurality of pre-processed audio tracks with different voiceprints;
conducting a motion identification on the plurality of feature blocks of each of the plurality of characters and labeling the plurality of feature blocks of each of the plurality of characters according to a motion identification result, wherein the motion identification result indicates one of the plurality of character motions; and
establishing the relation between the plurality of character motions and the plurality of pre-processed audio tracks.

8. The control method of video playback according to claim 6, wherein the step of acquiring the target character pattern in the current frame of the display interface according to the indication signal performed by the processor comprises:
determining a feature block among one or more of a plurality of feature blocks in the current frame that is closest to the frame coordinate as the target character pattern.

9. The control method of video playback according to claim 6, wherein the indication signal is a single-click signal and a trigger position of the single-click signal corresponds to the frame coordinate.

10. The control method of video playback according to claim 6, wherein the indication signal is a sliding signal, the sliding signal indicates a closed curve and a geometric center position of the closed curve corresponds to the frame coordinate.
